(19) United States
(12) Patent Application Publication
(10) Pub. No.: US 2008/0277387 A1
(43) Pub. Date: Nov. 13, 2008

(54) Use of Microwaves For Thermal and Non-Thermal Applications in Micro and Nanoscale Devices

(76) Inventors: James P. Landers, Charlottesville, VA (US); Susan Barker, Charlottesville, VA (US); N. Scott Barker, Charlottesville, VA (US)

Correspondence Address: BLANK ROME LLP, 600 NEW HAMPSHIRE AVENUE, N.W., WASHINGTON, DC, 20037, US

(21) Appl. No.: 11/793,428

(22) PCT Filed: Dec. 22, 2005
(86) PCT No.: PCT/US2005/046756

§ 371 Date: Jan. 7, 2008

Related U.S. Application Data
(60) Provisional application No. 60/638,261, filed on Dec. 22, 2004.

(51) Int. Cl. H05B 6/64

(52) U.S. Cl. 219/687

(57) ABSTRACT

The present invention relates to methods and systems for delivering microwave radiation, e.g., for heating, to a microfluidic device. The microfluidic device of the present invention contains a microwave integrated circuit (MMIC) for applying microwave radiation to specific areas within the microfluidic device. The circuit preferably includes a transmission line on one surface of the microfluidic device and a ground plane on the opposing surface.

This application claims priority of U.S. Provisional Patent Application Ser. No. 60/638,261, filed Dec. 22, 2004, which is incorporated herein by reference.

### FIELD OF THE INVENTION

The present invention relates to methods and systems for delivery of microwave radiation on a microfluidic device for heating and non-thermal applications. More specifically, the present invention relates to integrated microwave circuits on a microfluidic device for heating of samples and non-thermal applications and methods thereof.

### BACKGROUND OF THE INVENTION

There is an on-going need to miniaturize and multiplex the polymerase chain reaction (PCR) amplification process into a platform that is fast, convenient and inexpensive. Microtiter plate formats have been the main contributors to high throughput PCR but still utilize conventional block heater, or forced air thermocyclers. While the number of samples that can be cycled simultaneously (96, 384 or 1536) is impressive, amplification speed leaves much to be desired. The limitations associated with conventional thermocyclers in the past, primarily the rate at which the temperature can be changed, provides amplification times that are not as rapid as they could be. Consequently, amplification times on the order of an hour or more are still common.

In addition to PCR, numerous analytical methods require that a sample be heated to a particular temperature. Often, sequential heating and cooling steps, known as thermocycling, are required. Various methods involve cycling through two or more stages all with different temperatures, and/or involve maintaining the sample at a particular temperature stage for a given period of time before moving to the next stage. Accordingly, thermocycling of samples can become a time consuming process. In addition, these methods often require the precise control of temperature at each stage of the cycle; exceeding a desired temperature can lead to inaccurate results.

Generally, an increase in temperature of a reaction translates into an increase in the rate of the reaction. Reaction parameters, such as the activation of the reaction, the increase in dissolution of the reaction components, the desolvation of the substrate and the specificity of the catalysis are temperature dependent. Exact or nearly exact maintenance of a reaction temperature is often critical in most biochemical/biological processes to guarantee their successful completion. Therefore, great efforts are made in the daily routine of a chemical/biochemical laboratory to control the temperature conditions during a reaction. It is expected that better temperature control increases the performance of most reactions, for example, increasing the specificity of proteolytic reactions.

The microchip thermocycler provides a beneficial alternative to conventional block heater thermocyclers as a result of the smaller volumes involved as well as the ability to invoke the use of some novel methods for heating. Approaches for heating small volumes of solution have included the use of lasers (Slyadnev et al., Anal. Chem. 73:4037-4044, 2001; Lagally et al., Sensor Actuat B-Chem. 63:138-146, 2000), resistive heating (Northrup et al., Anal. Chem. 70:918-922, 1998), polysilicon heaters (Oda et al., Anal. Chem. 70:4361-4368, 1998), isothermal temperature zones (Kopp et al., Science 280:10460-1048, 1998) and tungsten lamps (Swerdlow et al. Anal Chem. 69(5):848-55, 1997; Huhmer et al., Anal. Chem. 72:5507-5512, 2000; Giordano et al., Anal. Biochem. 291:124-132, 2001; U.S. Pat. No. 6,210,882; and U.S. Pat. No. 6,413,766). Of these approaches, the resistive heating approach is most conducive to direction integration in the microchip platform as a result of the developments in the microelectronics industry. However, there is valid justification for the use of heating approaches that are non-contact in nature or have heating sources that are physically remote from the chip. These approaches allow for the complexity associated with the heating or temperature sensing to be built into the instrumentation and not the microchip, which translates to more cost-effective microchips. A number of heating methods fall into this category. One method involves the use of an infrared (IR) light to facilitate the heating of small volumes of solution in microchips, which has been shown to be possible (Huhmer et al.; Giordano et al.; U.S. Pat. Nos. 6,210,882 and 6,413,766) and, in fact, very efficient with small volume samples (Giordano et al.). Using a simple, expensive tungsten lamp (50 watts), small volumes of solution can be heated very rapidly. The basis for this is an excellent overlap between the wavelength of light emitted from a tungsten filament lamp and the absorption properties of water. A standard tungsten lamp emits light in the visible and infrared part of the electromagnetic spectrum, in general covering the 350 nm-3 μm wavelength range. This range includes the specific IR active absorption bands for water, specifically those at 2.66 μm and 2.78 μm. Consequently, the use of a tungsten lamp as an IR source where the higher energy wavelengths of light (<600 nm) are filtered provides an effective energy source in the 1-4 μm range where water absorbs maximally and leads to a vibrational transition of the water molecules. In addition, if light in this region is absorbed less effectively by the vessel containing the solution, selective heating of the solution (and not the microchip) results, which aids in rapid heating and in rapid cooling. This method have been used with microchips and shown the fastest PCR-amplification found in the literature to-date (U.S. Pat. No. 6,210,882).

While IR-PCR has now been shown to be effective for amplification of DNA in a variety of different formats including standard single or multiplexed amplifications using untagged primer sets as well as amplifications using fluorescently-tagged primers for cycle sequencing reactions, doing so in the multiplex format has been difficult. Fast cycling times can be attained with a reasonably efficient DNA amplification, but the task of multiplexing this new approach remains a challenge. Lagally et al. (Lab on a Chip, 1:102-107, 2001) has exploited the ease with which metals can be deposited on microchips and in microchip structures to multiplex resistive heating-based microchip PCR. Other approaches, e.g., Kopp et al's flow-through PCR, certainly may be amenable to multiplexing.

Microwave mediated PCR has been demonstrated using macro volumes with 2.5 mL (Orrling et al., Chem. Comm., 2004, 790-791) and 100 μL reaction volumes (Fermer et al., European Journal of Pharmaceutical Sciences 18:129-132, 2003). In these cases, single-mode microwave cavities were used to deliver microwave power to the sample, and due to the relatively large volumes of liquid being heated, these systems require very high microwave intensities in order to heat the solutions in a reasonable amount of time. Such high intensities are typically achieved through the use of magnetron sources delivering 500 to 1000 Watts and relatively large cavity resonators. However, in microchip systems, the solution volumes could range from as large as hundreds of microliters to as low as a few nanoliters or less. Such small volumes require substantially less energy to raise the solution temperature, e.g., 60° C. to 95° C. (on the order of 15 Joules). Thus, the magnetron source typically used in microwave heating applications, is not required and implementation of microwave heating on a microchip is possible.

U.S. Pat. No. 6,605,454 to Barenburg et al., which is incorporated herein by reference, discloses a microwave device having a monolithic microwave integrated circuit (MMIC) disposed therein for heating samples introduced into the microfluidic device and for effecting lysis of cells in the samples by applying microwave radiation. For efficient heating, the patent specifically targets dipole resonance frequency of water in the range of 18 to 26 GHz. This method, thus, is particularly efficient for heating water which is a major component of biological and most chemical systems studied in microfluidic devices. However, the high frequencies required for us with this approach render the system costly to operate and manufacture.

There remains a need, therefore, for improved methods and systems for a multiplex heating of small samples on a microchip that delivers heat to microfluidic devices in an economical and efficient manner. There is a further need for such methods and apparatus for use with miniaturized thermocycling, such as that for the polymerase chain reaction (PCR) amplification, binding reactions, chemical synthesis, chemical analysis, and the like.

### SUMMARY OF THE INVENTION

An object of the present invention method and system is to utilize microwave transmission lines to deliver microwave-mediated heating to specific areas in micro-devices. Specifically, the current invention specifically relates to, among other things, the delivery of high-density microwave power for in situ thermal and non-thermal effects in microfluidic devices.

Another object of the present invention is to provide a microfluidic device having a microwave integrated circuit (MMIC) for applying microwave radiation to specific areas within the microfluidic device. The MMIC may have a microstrip design, slot design, or a coplanar design. In one embodiment the MMIC is used to heat a sample in the microfluidic device.

Yet, another object of the present invention is to provide a microfluidic that efficiently heats small volumes of water at low cost. The MMIC preferably delivers microwave radiation at frequencies much lower than that of the dipole resonance of water. The MMIC of the present invention delivers microwave radiation in the frequency range of about 600 MHz-10 GHz. The relatively low frequency allows the present invention to be inexpensively produced and operated. Although these frequencies are lower than the resonance frequency of water, heating efficiency can be improved through circuit design of the MMIC, such as matching the impedance of the filled reaction chamber to the transmission line impedance.

Applications of the present invention include, but are not limited to, biological or chemical reactions (e.g., PCR), organic/inorganic chemical synthesis, spectroscopy, and biological studies in microchip technology platforms. Through the use of microwave transmission lines, integrated directly onto the surface of the microchip or located in close proximity, and transistor-based microwave power sources, a compact and very efficient microwave heating source can be developed for microchip systems. Because the volumes are small, the power requirement is low. The microwave heating can be controlled by either directly monitoring the solution temperature or, alternatively, remotely monitoring the solution temperature. Some of the advantages associated with at least some of the embodiments of the present invention include, but not limited thereto, the ability to overcome obstacles associated with multiplexing biological or chemical reactions with standard sources of heating (lasers, IR lamps)—these are associated with disadvantages that include cost, complicated multiplexing or complex optics. Some embodiments of the current invention would be associated with a microwave control circuitry that would allow microwave power to be independently delivered to multiple areas on the microchip using a single microwave source, resulting in the ability to multiplex microchip-based chemical reactors in a matter of minutes. The ability to deliver microwave heating to specific areas of microdevices will allow implementation of microwave applications (bio/chemical reactions, biological studies,) on microscale devices.

### BRIEF DESCRIPTION OF THE DRAWINGS

FIG. 1 is a plan view of an embodiment of the present invention.

FIG. 2 is a cross-sectional view along the A-A plane.

FIG. 2 is a cross-sectional view along the B-B plane.

### DETAILED DESCRIPTION OF THE PREFERRED EMBODIMENT

The present invention is generally directed to apparatuses and methods for performing heating and/or thermocycling of small volume samples on a microchip or microfluidic apparatus using microwave radiation. The term “small volume” as used herein refers to volumes in the picoliters (pL) to microliters (μL) range, preferably about 100 pL to about 100 μL, most preferably about 1 nL to about 10 μL. The term “microfluidic” as used herein refers to an apparatus for analysis of small volumes of sample, and containing microscale components for fluid processing, such as channels, pumps, micro-reaction chambers, electrophoresis modules, microchannels, fluid reservoirs, detectors, valves, or mixers. These microfluidic apparatuses are also referred to as micro-total analysis systems (μTAS). “Micro” as used herein refers to small components and is not restricted to micron or microliter scale, but also include smaller components in the nanometer or nanoliter range.

Applications of the microwave heating method of the present invention are numerous and generally encompass any system in which the temperature of a sample is regulated and/or changed. The present invention is particularly applicable to analytical systems wherein fast or ultrafast transition from one temperature to the next is needed, and in which it is important that exact or nearly exact temperatures be achieved.

For example, the present apparatus and methods are suitable for testing and incubation and treatment of biological samples typically analyzed in a molecular biology laboratory or a clinical diagnostic setting. The accuracy of the heating method of the present invention makes it particularly suitable for use in nucleic acid replication by the polymerase chain reaction (PCR). Any reaction that benefits from precise temperature control, rapid heating and cooling, continuous thermal ramping or other temperature parameters or variations can be accomplished using this method discussed herein. Other applications include, but are not limited to, chemical reactions and synthesis, the activation and acceleration of enzymatic reactions, the deactivation of enzymes, the treatment/incubation of protein-protein complexes, nucleic acid-protein complexes, nucleic acid—nucleic acid complexes and complexes of any of these biomolecules with drugs and/or other organic or inorganic compounds to induce folding/unfolding and the association/dissociation of such complexes. The following applications illustrate the usefulness of the present thermocycling apparatus and methods, representing only some of the possible applications.

A common procedure in the protocols of molecular biology is the deactivation of proteins through heat. One of the most basic procedures in molecular biology is the cleavage of proteins and peptides into discrete fragments by proteases/digestion enzymes, such as trypsin. A thermocycling procedure is typically used to activate the enzyme at an elevated temperature followed by: the incubation of the enzyme during the reaction to sustain the enzymatic catalysis; the heat inactivation of the enzyme; and the final treatment/analysis at ambient temperature. Typically, the reaction components are incubated at 40° C. for 60 minutes until the reaction is completed, after which the enzyme activity has to be stopped to avoid unspecific cleavage under uncontrolled conditions. Many enzymes, such as trypsin, can be irreversibly inactivated by incubation for 10 minutes at higher temperature, such as 95° C. The sample is then cooled back to ambient temperature and ready for downstream analysis. Such deactivation of enzymes is taught, for example, in Sequencing of proteins and peptides: Laboratory Techniques in Biochemistry and Molecular Biology, ed. G. Allen, pages 73-105.

The same principle of heat inactivation can be used to inactivate restriction endonucleases that recognize short DNA sequences and cleave double stranded DNA at specific sites within or adjacent to the recognition sequence. Using the appropriate assay conditions (for example, 40° C. for 60 min), the digestion reaction can be completed in the recommended time. The reaction is stopped by incubation of the sample at 65° C. for 10 minutes. Some enzymes may be partially or completely resistant to heat inactivation at 65° C., but they may be inactivated by incubation for 15 minutes at 75° C. Such methods are taught, for example, by Ausubel et al. Short Protocols in Molecular Biology, 3rd Ed., John Wiley & Sons, Inc. (1995) and Molecular Cloning: A Laboratory Manual, J. Sambrook, Eds. E. F. Fritsch, T. Maniatis, 2nd Ed.

Similar to the heat inactivation of proteins for the control of enzymatic activity, the sample processing of proteins for electrophoretic analysis often requires the denaturation of the protein/peptide analyte before the separation by electrophoretic means, such as gel electrophoresis and capillary electrophoresis, takes place. For example, a 5 minute heat denaturation (which provides for the destruction of the tertiary and secondary structure of the protein/peptide) at 95° C. in an aqueous buffer in the presence or absence of denaturing reagents, such as SDS detergent, allows the size dependent separation of proteins and peptides by electrophoretic means. That is taught, for example, in Gel Electrophoresis of Proteins: A Practical Approach, Eds. B. D. Hames and D. Rickwood, page 47, Oxford University Press (1990).

Thermocycling of samples is also used in a number of nonenzymatic processes, such as protein/peptide sequencing by hydrolysis in the presence of acids or bases (for example, 6M HCl at 110° C. for 24 hours) into amino acids. Studies involving the investigation of the interaction of biomolecules with drugs and/or drug candidates are frequently conducted under conditions requiring precise temperature control to obtain binding characteristics, such as kinetic association/dissociation constants.

Those applications for the heating and/or thermocycling taught by the present invention will find use, for example, as a diagnostic tool in hospitals and laboratories such as for identifying specific genetic characteristics in a sample from a patient, in biotechnology research such as for the development of new drugs, identification of desirable genetic characteristics, etc., in biotechnology industry-wide applications, in chemical synthesis, or in medical research, e.g., investigating the effect of microwave frequencies on cells and biological molecules, and in other scientific research and development efforts.

The present invention provides a device and method for applying substantially localized microwave radiation to samples in a microfluidic device. More specifically, the present invention provides microfluidic apparatuses or devices that have a microwave integrated circuit (MMIC) integrated into the device. The MMIC is used to apply microwave radiation to a micro-heating area or microwave radiation area defined by the device for enhancing or affecting a reaction or process taking place therein. In addition, as outlined herein, the devices of the invention can include, but is not limited to, the following components: one or more wells for sample manipulation, waste or reagents; microchannels to and between these wells, including microchannels containing sample preparation or electrophoretic separation matrices; valves to control fluid movement; and on-chip pumps. The devices of the invention can be configured to manipulate one or multiple samples.

The MMIC designs of the present invention include, but are not limited to, microstrip designs, slot designs, and coplanar designs. See, e.g., Gallium Arsenide Technology, Chs. 6-7 edited by David Kerry (Howard W. Sams & Co. 1985); Microwave Circuit Analysis and Amplifier Design, Liao S. (Prentice-Hall, 1987); Computer Aided Design of Microwave Circuits, Gupta et al. (Artech House 1981); all of which are incorporated herein by reference.

In a preferred embodiment, the MMIC designs of the present invention provide high frequency absorption. By integration of an appropriate microwave circuit into a microfluidic device in accordance with the present invention, a precise, reliable and substantially localized application of microwave radiation to a sample in the microfluidic device is made possible. As the skilled artisan will appreciate, this enhances or makes possible many types of reactions and processes within a microfluidic device. For example, and without limitation, microwave irradiation has been shown to improve nucleic acid extraction from microorganisms, which is an essential step in many biochemical and biomedical.

Accordingly, the present invention provides MMIC devices. As used herein, the term “monolithic microwave integrated circuit” or “MMIC” refers to a combination of interconnected microwave circuit elements integrated on a substrate.

The integrated circuits are on a substrate. The composition of the solid substrate will depend on a variety of factors, including the techniques used to create the device, the use of the device, the composition of the sample, the analyte to be detected, the size of the wells and microchannels, the presence or absence of electronic components, etc. Generally, the devices of the invention should be easily sterilizable as well. The integrated circuit and the fluidics maybe formed in the same substrate or in different substrates.

In a preferred embodiment, the solid substrate can be made from a wide variety of materials, including, but are not limited to, silicon such as silicon wafers, silicon dioxide, silicon nitride, ceramics, glass and fused silica, gallium arsenide, indium phosphide, aluminum, ceramics, polyimide, quartz, composite materials, fiberglass, FR-4, plastics, resins and polymers including polyimide, polymethylmethacrylate, acrylics, polyethylene, polyethylene terepthalate, polycarbonate, polystyrene and other styrene copolymers, polypropylene, polytetrafluoroethylene, superalloys, KOVAR, KEVLAR, KAPTON, MYLAR, sapphire, etc. High quality glasses such as high melting borosilicate or fused silicas may be preferred for their UV transmission properties when any of the sample manipulation steps require light based technologies. In addition, as outlined herein, portions of the internal surfaces of the device may be coated with a variety of coatings as needed, to reduce non-specific binding, to allow the attachment of binding ligands, for biocompatibility, for flow resistance, etc. Most preferably, the substrates are made from glass or plastics.

There are many formats, materials, and size scales for constructing microfluidic devices. Common microfluidic devices are disclosed in U.S. Pat. No. 6,692,700 to Handique et al.; U.S. Pat. No. 6,919,046 to O'Connor et al.; U.S. Pat. No. 6,551,841 to Wilding et al.; U.S. Pat. No. 6,630,353 to Parce et al.; U.S. Pat. No. 6,620,625 to Wolk et al.; and U.S. Pat. No. 6,517,234 to Kopf-Sill et al.; all of which are incorporated herein by reference. Typically, a microfluidic device is made up of two or more substrates that are bonded together. Microscale components for processing fluids are disposed on a surface of one or more of the substrates. These microscale components include, but are not limited to, micro-reaction chambers, solid phase extraction modules, electrophoresis modules, microchannels, fluid reservoirs, detectors, valves, or mixers. When the substrates are bonded together, the microscale components are enclosed and sandwiched between the substrates. In many embodiments, at least inlet and outlet ports are engineered into the device for introduction and removal of fluid from the system. The microscale components can be linked together to form a fluid network for chemical and biological analysis. Those skilled in the art will recognize that substrates composed of silicon, glass, ceramics, plastics, polymers, metals and/or quartz are all acceptable in the context of the present invention. Further, the design and construction of the microfluidic network vary depending on the analysis being performed and are within the ability of those skilled in the art.

The devices may comprise conductors for the transmission of microwave radiation. Suitable transmission lines include, but are not limited to, microstrip line conductors and slot line conductors, both of which are well known in the art.

The position, orientation and number of conductors can vary widely, as will be appreciated by those in the art. In a preferred embodiment, the conductors are placed adjacent to the micro-area for which microwave radiation is desired. By “adjacent” herein is meant that the conductors are close enough to deliver microwave radiation to the sample within the desired micro-area.

In addition to the micro-heating or irradiation area, the devices of the invention can include other components, such as one or more wells for sample manipulation, waste or reagents; microchannels to and between these wells, including microchannels containing sample preparation or electrophoretic separation matrices; valves to control fluid movement; on-chip pumps such as electroosmotic, electrohydrodynamic, or electrokinetic pumps; and detection systems, such as optical or electrical detection systems. The devices of the invention can be configured to manipulate one or multiple samples or analytes. Any of these other microscale components can also be heated as well using a microwave circuit. A microfluidic chip may contain more than one micro-heating or irradiation areas.

In an embodiment, the solid substrate is configured for handling a single sample that may contain a plurality of target analytes. That is, a single sample is added to the device and the sample may either be aliquoted for parallel processing for detection of the analytes or the sample may be processed serially, with individual targets being detected in a serial fashion. In addition, samples may be removed periodically or from different locations for in line sampling.

In a preferred embodiment, the solid substrate is configured for handling multiple samples, each of which may contain one or more target analytes. In general, in this embodiment, each sample is handled individually; that is, the manipulations and analyses are done in parallel, with preferably no contact or contamination between them. Alternatively, there may be some steps in common; for example, it may be desirable to process different samples separately but detect all of the target analytes in a single detection region.

In addition, it should be understood that while most of the discussion herein is directed to the use of planar substrates with microchannels and wells, other geometries can be used as well. For example, two or more planar substrates can be stacked to produce a three dimensional device, that can contain microchannels flowing within one plane or between planes; similarly, wells may span two or more substrates to allow for larger sample volumes. Thus for example, both sides of a substrate can be etched to contain microchannels; see for example U.S. Pat. Nos. 5,603,351 and 5,681,484, both of which are incorporated herein by reference.

Thus, the devices of the invention include at least one microchannel or flow channel that allows the flow of sample from the sample inlet port to the other components or modules of the system. The collection of microchannels and wells is sometimes referred to in the art as either a “micro Total Analysis Systems” (μTAS) or “mesoscale flow system” when larger volumes are used. As will be appreciated by those in the art, the flow channels may be configured in a wide variety of ways, depending on the use of the channel. For example, a single flow channel starting at the sample inlet port may be separated into a variety of smaller channels, such that the original sample is divided into discrete sub-samples for parallel processing or analysis. Alternatively, several flow channels from different modules, for example the sample inlet port and a reagent storage module may feed together into a mixing chamber or a reaction chamber. As will be appreciated by those in the art, there are a large number of possible configurations; what is important is that the flow channels allow the movement of sample and reagents from one part of the device to another. For example, the path lengths of the flow channels may be altered as needed; for example, when mixing and timed reactions are required, longer and sometimes tortuous flow channels can be used.

In general, the microfluidic devices of the invention are generally referred to as microscale devices, but nanoscale or “mesoscale” devices could also be employed. The devices herein are typically designed on a scale suitable to analyze microvolumes, although in some embodiments large samples (e.g. cc's of sample) may be reduced in the device to a small volume for subsequent analysis. That is, “microscale” as used herein refers to chambers and microchannels that have cross-sectional areas on the order of 0.1-3000 μm². The microscale flow channels and wells have preferred depths on the order of 0.1-500 μm. The channels have preferred widths on the order of 0.2-1000 μm, more preferably 3-100 μm. For many applications, channels of 5-500 μm are useful. However, for many applications, larger “mesoscale” dimensions on the scale of millimeters may be used. Similarly, chambers in the substrates often will have larger dimensions than the microchannels, on the scale of 1-3 mm (width and depth). When very small sample volumes may be used, nanoscale devices are useful.

In addition to the flow channel system, the devices of the invention are configured to include one or more of a variety of components that will be present on any given device depending on its use. These components include, but are not limited to, sample inlet ports; sample introduction or collection modules; cell handling modules (for example, for cell lysis (including the microwave lysis of cells as described herein), cell removal, cell concentration, cell separation or capture, cell growth, etc.); separation modules, for example, for electrophoresis, gel filtration, ion exchange/affinity chromatography (capture and release) etc.; reaction modules for chemical or biological reactions or alteration of the sample, including amplification of the target analyte (for example, when the target analyte is nucleic acid, amplification techniques are useful, including, but not limited to polymerase chain reaction (PCR), real-time PCR, ligase chain reaction (LCR), strand displacement amplification (SDA), whole genome amplification (WGA), and nucleic acid sequence based amplification (NASBA)), chemical, physical or enzymatic cleavage or alteration of the target analyte, or chemical modification of the target; fluid pumps; fluid valves; thermal modules for heating and cooling; storage modules for assay reagents; mixing chambers; and detection modules.

The devices of the invention may include at least one sample inlet port for the introduction of the sample to the device. This may be part of or separate from a sample introduction or collection module; that is, the sample may be directly fed in from the sample inlet port to a separation chamber, or it may be pretreated in a sample collection well or chamber.

The devices of the invention may include a sample collection module, which can be used to concentrate or enrich the sample if required; for example, see U.S. Pat. No. 5,770,029, which is incorporated herein by reference.

The devices of the invention may include a cell handling module. This is particularly useful when the sample comprises cells that either contain the target analyte or that must be removed in order to detect the target analyte. Thus, for example, the detection of particular antibodies in blood can require the removal of the blood cells for efficient analysis, or the cells (and/or nucleus) must be lysed prior to detection. In this context, “cells” include eukaryotic and prokaryotic cells as outlined herein, and viral particles that may require treatment prior to analysis, such as the release of nucleic acid from a viral particle prior to detection of target sequences. In addition, cell handling modules may also utilize a downstream means for determining the presence or absence of cells. Suitable cell handling modules include, but are not limited to, cell lysis modules, cell removal modules, cell concentration modules, and cell separation or capture modules. In addition, as for all the modules of the invention, the cell handling module is in fluid communication via a flow channel with at least one other module of the invention.

In a preferred embodiment, the devices of the invention include a separation module. This can comprise the separation or isolation of the target analyte, or the removal of contaminants that interfere with the analysis of the target analyte, depending on the assay. The separation module includes chromatographic-type separation media such as absorptive phase materials, including, but not limited to reverse phase materials, ion-exchange materials, affinity chromatography materials such as binding ligands, etc. See U.S. Pat. No. 5,770,029, which is incorporated herein by reference. The separation module can utilize binding ligands. In this embodiment, binding ligands are preferably immobilized (again, either by physical absorption or covalent attachment, described below) within the separation module (again, either on the internal surface of the module, on a particle such as a bead, filament or capillary trapped within the module, for example through the use of a frit). Suitable binding moieties will depend on the sample component to be isolated or removed. “Binding ligand” as used herein refers to a compound that is used to bind a component of the sample, either a contaminant (for removal) or the target analyte (for enrichment). The binding ligand can also be used to probe for the presence of the target analyte by binding to the analyte.

The devices of the invention may include a reaction chamber. This can include either physical, chemical, or biological alteration of one or more sample components. Alternatively, it may include a reaction chamber wherein the target analyte alters a second moiety that can then be detected; for example, if the target analyte is an enzyme, the reaction chamber may comprise an enzyme substrate that upon modification by the target analyte, can then be detected. In this embodiment, the reaction module may contain the necessary reagents, or they may be stored in a storage module and pumped to the reaction module as needed.

The devices of the invention may include a detection module used to detect target analytes in samples. By “target analyte” or “analyte” herein is meant to be any molecule, compound or particle to be detected. Target analytes preferably binds to binding ligands, as is more fully described above. The detection module can include detectors that are incorporated into the device or be aligned with a detector that is not incorporated into the device. In some instances, the detection section includes the flow channel in which the thermal cycling reaction takes place. In other designs, the detection section is located at another part of the device, typically downstream from an outlet connected to the flow channel in which thermal cycling occurs. Because the microfluidic devices provided herein can be made from optically transparent materials, the devices can be used with certain optical detection systems that cannot be utilized with conventional devices manufactured from silicon. A large number of analytes may be detected using the present methods; basically, any target analyte for which a binding ligand, described herein, may be made may be detected using the methods of the invention. Detection methods for PCR or other amplification-related reactions are disclosed in U.S. Pat. No. 6,960,437, which is incorporated herein by reference. As will be appreciated by those in the art, the particular detection method employed depends upon the nature of the reactant and/or product being detected.

The device of the present invention is preferably used in conjunction with an apparatus for cooling, such as that disclosed by U.S. Pat. No. 6,413,766 to Landers et al., which is incorporated herein by reference. Cooling to a desired temperature can be effected in one step, or in stepwise reductions with a suitable dwell time at each temperature step. Cooling can be accomplished by any methods available including, but are not limited to, forced air, contact cooling, Peltier cooling, passive cooling, and chemical cooling. Positive cooling is preferably effected by use of a non-contact air source that forces air at or across the vessel. Preferably, that air source is a compressed air source, although other sources could also be used. It will be understood by those skilled in the art that positive cooling results in a more rapid cooling than simply allowing the vessel to cool to the desired temperature by heat dissipation. Cooling can be accelerated by contacting the selected areas with a heat sink comprising a larger surface than the selected areas themselves; the heat sink is cooled through the non-contact cooling source. The cooling effect can also be more rapid if the air from the non-contact cooling source is at a lower temperature than ambient temperature.

Accordingly, the non-contact cooling source should also be positioned remotely to the sample or reaction vessel, while being close enough to effect the desired level of heat dissipation. Both the heating and cooling sources should be positioned so as to cover the largest possible surface area on the sample vessel. The heating and cooling sources can be alternatively activated to control the temperature of the sample. It will be understood that more than one cooling source can be used.

Positive cooling of the reaction vessel dissipates heat more rapidly than the use of ambient air. The cooling means can be used alone or in conjunction with a heat sink. A particularly preferred cooling source is a compressed air source. Compressed air is directed at the selected areas when cooling of the sample is desired through use, for example, of a solenoid valve which regulates the flow of compressed air at or across the selected areas. The pressure of the air leaving the compressed air source can have a pressure of anywhere between 10 and 60 PSI, for example. Higher or lower pressures could also be used. The temperature of the air can be adjusted to achieve the optimum performance in the thermocycling process. Although in most cases compressed air at ambient temperature can create enough of a cooling effect, the use of cooled, compressed air to more quickly cool the sample, or to cool the sample below ambient temperature might be desired in some applications.

A device for monitoring the temperature of the sample, and a device for controlling the heating and cooling of the sample, may also be provided. Generally, such monitoring and controlling is accomplished by use of a microprocessor or computer programmed to monitor temperature and regulate or change temperature. An example of such a program is the Labview program (National Instruments, Austin, Tex.). Feedback from a temperature sensing device, such as a thermocouple or a remote temperature sensor, is sent to the computer. In one embodiment, the temperature sensing device provides an electrical input signal to the computer or other controller, which signal corresponds to the temperature of the sample. Preferably, the thermocouple, which can be coated or uncoated, is placed adjacent to the selected portions of the microfluidic device where rapid heating and/or cooling is desired. Alternatively, the thermocouple can be placed directly into the microscale component, provided that the thermocouple does not interfere with the particular reaction or affect the thermocycling, and provided that the thermocouple used does not act as a significant heat sink. A suitable thermocouple for use with the present invention is constantan-copper thermocouple.

In a preferred embodiment, temperature is monitored and controlled through a remote temperature sensing means. For example, an optical sensing device can be placed above a reaction vessel containing the sample being thermocycled. Such a device can sense the temperature in a chamber or on the surface of the chamber, here the sample reaction chamber, when positioned remotely from the selected areas.

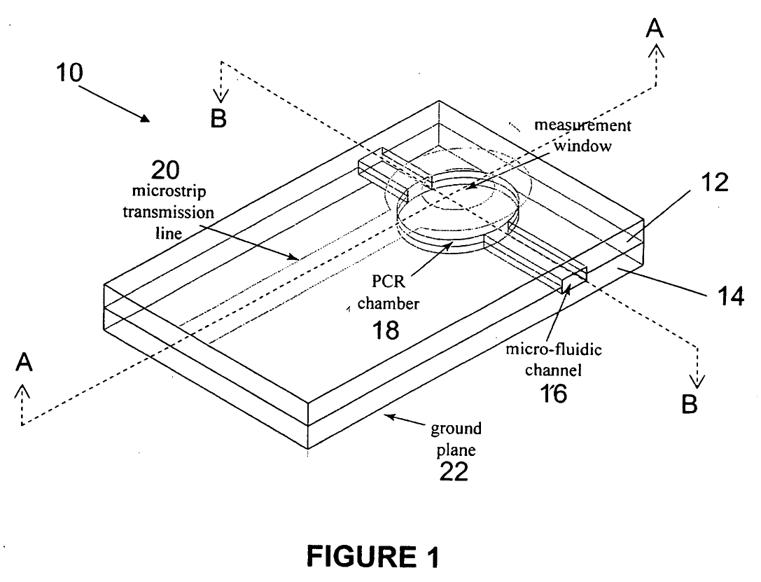

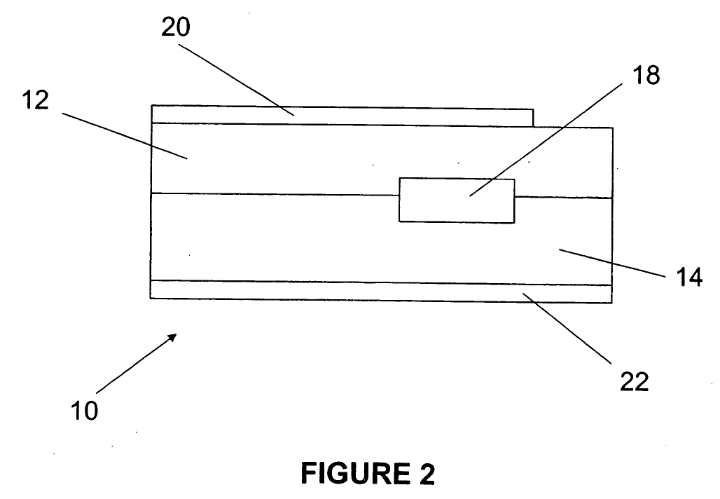

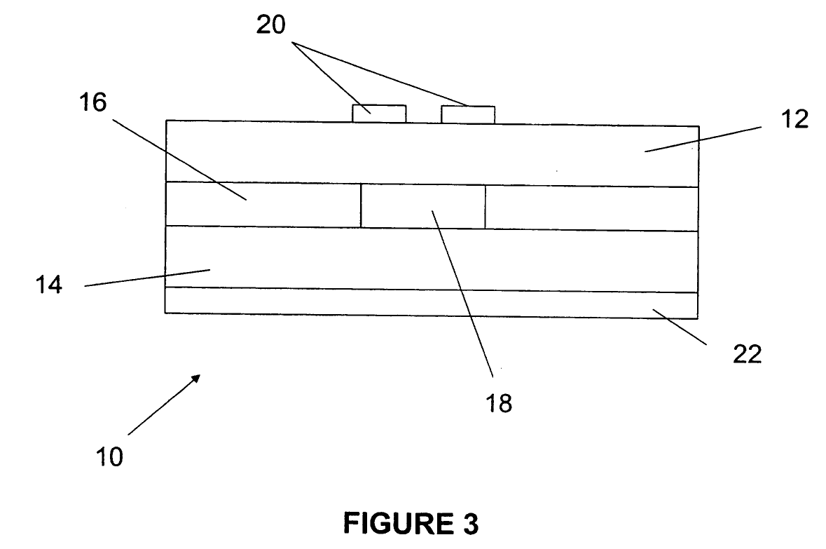

A microfluidic device of the present invention, in its simplest form is illustrated in FIGS. 1-3. The microfluidic device 10 includes top substrate 12, bottom substrate 14, and a microstrip MMIC, which is discussed in more detail below. The top and bottom substrates 12 and 14 defines a microchannel 16 and a chamber 18. The MMIC is defined by a microstrip transmission line 20 and ground plane conductor 22, together with the material between conductors 20 and 22. The microstrip transmission line 20 is formed on the top surface 26 of the microfluidic device 10; and the ground plane is formed on the bottom surface 28 of the microfluidic device 10.

As will be appreciated by the skilled artisan, the MMIC described herein have a microwave source connected thereto. Preferably, an amplifier and/or coupler is connected between the microwave source and the MMIC in a manner known to the skilled artisan. This source consists of a compact surface-mount microwave oscillator followed by a power amplifier chip capable of delivering on the order of 5 W. The source and power amplifier will operate within the frequency range of 500 MHz to 10 GHz, preferably from about 800 MHz to 8 GHz, most preferably from about 1 GHz to 5 GHz. This source preferably can be controlled rapidly through the use of high-speed microwave switches capable of switching in the nanosecond time regime. The microwave power will be delivered to the specific areas of the microdevice via microstrip transmission lines integrated onto or in close proximity to the chip. These transmission lines have very low loss and, with proper design, will allow efficient delivery of the microwave power directly into specific areas, such as an on-chip PCR chamber. In addition, microstrip transmission lines are very simple structures requiring a solid metal ground plane on one side of the chip and a metal strip on the other. Therefore, the addition of these transmission lines to a disposable chip will not add significantly to the overall chip cost. This miniature microwave power delivery can be applied to a single micro-area of the chip (e.g., a microchamber) but clearly can be extrapolated to multiple areas on the chip, with the only limitation being the density of micro-structures.

For efficient delivery of microwave energy to the reaction chamber, it is necessary to match the impedance of the filled reaction chamber to the transmission line impedance. As an example, we consider the case of a 1 μL chamber filled with pure water.

At 25° C. and 900 MHz, the complex permittivity of pure water is ε=(78−j3.4) εₒ (where ε₀ is the permittivity of free space). It is the imaginary component that converts the microwave energy into heat. Using this value, an equivalent resistance for the microchamber, as seen by the transmission line, can be calculated as follows:

σ=(2π)(900 MHz)(3.4ε₀)=0.168 S/m

R=l/(σA)

For a 1×10⁻⁶ L cylindrical microchamber, the dimensions are

depth: l=100 μm

radius: r=1.9 mm (A=πr²=11.3×10⁻⁶m²)

This results in an equivalent resistance of:

R=52.7Ω

This resistance is very close to the standard transmission line impedance used for microwave circuit design (50Ω). The significance of this is that it will be possible to deliver microwave power into the water within the microchamber very efficiently.

In addition to this equivalent resistance there is also an equivalent capacitance in parallel due to the real component of the complex permittivity (78εₒ). This capacitance can be tuned out, using an appropriate parallel inductance, in order to maintain an efficient match between the transmission line and the reaction chamber.

Additionally, a computer or on-chip CPU is preferably used to monitor the parameters (such as temperature) in the chamber and control the microwave source and amplifier to achieve predetermined parameters for the chamber. This computer can also be used to control temperature and other parameters in operation of the microfluidic device.

The present invention also provides microfabrication processes for making microfluidic devices that include MMICs. The devices of the invention can be made in a variety of ways, as will be appreciated by those skilled in the art. See for example WO96/39260, directed to the formation of fluid-tight electrical conduits. U.S. Pat. No. 5,747,169, directed to sealing; EP 0637996 B1; EP 0637998 B1; WO96/39260; WO97/16835; WO98/13683; WO97/16561; WO97/43629; WO96/39252; WO96/15576; WO96/15450; WO97/37755; and WO97/27324; and U.S. Pat. Nos. 5,304,487; 5,071,531; 5,061,336; 5,747,169; 5,296,375; 5,110,745; 5,587,128; 5,498,392; 5,643,738; 5,750,015; 5,726,026; 5,35,358; 5,126,022; 5,770,029; 5,631,337; 5,569,364; 5,135,627; 5,632,876; 5,593,838; 5,585,069; 5,637,469; 5,486,335; 5,755,942; 5,681,484; and 5,603,351, all of which are incorporated herein by reference. Suitable fabrication techniques again will depend on the choice of substrate, but preferred methods include, but are not limited to, a variety of micromachining and microfabrication techniques, including film deposition processes such as spin coating, chemical vapor deposition, laser fabrication, photolithographic and other etching techniques using either wet chemical processes or plasma processes, embossing, injection molding and bonding techniques (see U.S. Pat. No. 5,747,169, which is incorporated herein by reference). In addition, there are printing techniques for the creation of desired fluid guiding pathways; that is, patterns of printed material can permit directional fluid transport. See for example U.S. Pat. No. 5,795,453, which is incorporated herein by reference.

Photolithographic methods of etching substrates are particularly well suited for the microfabrication of these substrates and are well known in the art. For example, the first sheet of a substrate may be overlaid with a photoresist. Radiation may be applied through a photolithographic mask to expose the photoresist in a pattern which reflects the pattern of chambers and/or channels on the surface of the sheet. After removing the exposed photoresist, the exposed substrate may be etched to produce the desired wells and channels. Generally preferred photoresists include those used extensively in the semi-conductor industry. Such materials include polymethyl methacrylate (PMMA) and its derivatives, and electron beam resists, such as polyolefin sulfones and the like (more fully discussed in, e.g., Ghandi, “VLSI Fabrication Principles,” Wiley (1983) Chapter 10, which is incorporated herein by reference).

Although certain presently preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

What is claimed is:

1. A method for performing heating or delivering microwave radiation to a micro-heating area on a microfluidic device comprising the steps of
a) providing the microfluidic device having the micro-area and a microwave circuit disposed thereon;
b) providing a sample in the micro-area; and
c) applying microwave radiation to the micro-area a frequency of about 500 MHz to 10 GHz.

2. The method of claim 1, wherein the microwave radiation frequency is less than the resonance frequency of water.

3. The method of claim 1, wherein the micro-area comprises is selected from the group consisting of a sample loading reservoir, a thermocycling chamber, and a recovery reservoir fluidically connected with each other.

4. The method of claim 1, wherein the impedance of the micro-area is approximately the same as the impedance of a transmission line of the microwave circuit.

5. The method of claim 1, wherein the micro-area is a PCR chamber.

6. The method of claim 1, wherein the micro-area is a chamber for biological or chemical reaction.

7. A microfluidic device comprising
at least one micro-area; and
a microwave circuit disposed on or adjacent to the device, wherein said microwave circuit is designed to operate at about 500 MHz to 10 GHz.

8. The microfluidic device of claim 7, wherein the microwave radiation frequency is less than the resonance frequency of water.

9. The microfluidic device of claim 7, wherein the micro-area is selected from the group consisting of a sample loading reservoir, a thermocycling chamber, a recovery reservoir, a reaction chamber, an electrophoresis module, a microchannel, and a fluid reservoir.

10. The microfluidic device of claim 7, wherein the micro-area has approximately the same impedance as that of a transmission line of the microwave circuit.

11. The microfluidic device of claim 7, wherein the micro-area is a PCR chamber.

12. The microfluidic device of claim 7, wherein the micro-area is a chamber for biological or chemical reaction.

13. A system for thermal cycling, comprising:
the microfluidic device of claim 7 operably connected to a microwave source;
a cooling source for cooling the at least one micro-heating area; and
a temperature sensor for monitoring the temperature of the at least one micro-heating area.

14. The system of claim 13, wherein the cooling source is selected from the group consisting of forced air cooling, contact cooling, Peltier cooling, passive cooling, and chemical cooling.

15. The system of claim 13, wherein the temperature sensor is a thermocouple or a remote temperature sensor.

16. The system of claim 13, wherein the microwave radiation frequency is less than the resonance frequency of water.

17. The system of claim 13, wherein the micro-area is selected from the group consisting of a sample loading reservoir, a thermocycling chamber, a recovery reservoir, a reaction chamber, an electrophoresis module, a microchannel, and a fluid reservoir.

18. The system of claim 13, wherein the micro-area has approximately the same impedance as that of a transmission line of the microwave circuit.

19. The system of claim 13, wherein the micro-area is a PCR chamber.

20. The system of claim 13, wherein the micro-area is a chamber for biological or chemical reaction.
